(19) United States
(12) Patent Application Publication
(10) Pub. No.: US 2014/0098141 A1
(43) Pub. Date: Apr. 10, 2014

(54) Method and Apparatus for Securing Input of Information via Software Keyboards

(71) Applicant: AT&T INTELLECTUAL PROPERTY I, L.P., Atlanta, GA (US)

(72) Inventors: Subhabrata Sen, New Providence, NJ (US); Suhrid Balakrishnan, Scotch Plains, NJ (US); Emiliano Miluzzo, Madison, NJ (US); Alexander Varshavsky, East Hanover, NJ (US)

(73) Assignee: AT&T INTELLECTUAL PROPERTY I, L.P., Atlanta, GA (US)

(21) Appl. No.: 13/648,549

(22) Filed: Oct. 10, 2012

(51) Int. Cl. G09G 5/00

(52) U.S. Cl. 345/660

(57) ABSTRACT

Data entry using a software keyboard such as a touchscreen keyboard is secured by varying key sizes in the keyboard from key to key and from software keyboard configuration to software keyboard configuration, decoupling display locations from keys. Multiple software keyboard configurations are generated, each having different sets of key sizes. The keyboard configuration may be changed with each keystroke, or may be changed for each prompted entry including multiple keystrokes.

### FIELD OF THE DISCLOSURE

The present disclosure relates generally to the protection of data in electronic devices, and more particularly to the discouragement or prevention of keystroke logging in a device receiving data via a software keyboard instantiated on a touchscreen.

### BACKGROUND

A wide range of applications and devices increasingly use Graphical User Interface (GUI) metaphors such as software keyboards (soft-keyboards) for users to enter sensitive information such as financial account credentials and single sign-on passwords. One reason for this trend is to avoid the risk of key logging software capturing keystroke information as it is entered on a traditional keyboard. Recent studies have shown, however, that input using a software keyboard is not secure and that the information being entered can be reverse engineered by malicious software. In particular, it has been shown that it is possible to draw correlations between the keys being tapped on a touch screen and accelerometer and gyroscope sensor data generated by the device.

### SUMMARY OF THE DISCLOSURE

In accordance with one aspect of the present disclosure, there is described a method for securing data input via a graphical user interface. The method generally comprises generating a first software keyboard configuration including a plurality of key representations having a first set of predetermined sizes; causing a first software keyboard to be displayed on a touch screen according to the first software keyboard configuration; receiving data from the touchscreen, the data being keyed using the first software keyboard; generating a second software keyboard configuration including a plurality of key representations having a second set of predetermined sizes, the second set of predetermined sizes being different from the first set of predetermined sizes; causing a second software keyboard to be displayed on a touch screen according to the second software keyboard configuration; and receiving data from the touchscreen, the data being keyed using the second software keyboard.

In accordance with another aspect of the present disclosure, a tangible computer-usable medium is provided, having computer readable instructions stored thereon for execution by one or more processors to perform operations for securing data input via a graphical user interface as described above.

These aspects of the disclosure and further advantages thereof will become apparent to those skilled in the art as the present disclosure is described with particular reference to the accompanying drawings.

### BRIEF DESCRIPTION OF THE DRAWINGS

FIG. 1 is a partial schematic view of a prior art software keyboard configuration.

FIGS. 2a and 2b are partial schematic views of keyboard configurations in accordance with disclosed embodiments.

FIGS. 3a and 3b are partial schematic views of keyboard configurations in accordance with other disclosed embodiments.

FIG. 4 is a partial flowchart showing a method in accordance with an embodiment of the disclosure.

FIG. 5 is a partial flowchart showing a method in accordance with an embodiment of the disclosure.

FIGS. 6a-6c are views of a touchscreen of a device displaying a software keyboard in accordance with embodiments of the disclosure.

FIG. 7 is a partial schematic view of a keyboard configuration in accordance with one disclosed embodiment.

FIGS. 8a-8c are views of a touchscreen of a device displaying a software keyboard in accordance with embodiments of the disclosure.

FIG. 9 is a schematic diagram of an apparatus in accordance with embodiments of the disclosure.

### DETAILED DESCRIPTION

A broad range of applications and services depend on users being able to securely enter information (passwords, pass phrases, account numbers and other types of authentication data) online. Examples include applications that identify or authenticate users for online services, such as financial accounts. Financial sites including online banking and brokerage services, e-commerce shopping sites, enterprise apps, and in-the-middle transaction services such as single-sign-on vendors, etc., all frequently involve the secure input of sensitive information.

Single sign-on (SSO) systems are increasingly used to handle the large number of passwords and other credentials typically dealt with by a user. A single sign-on is a form of access control in which a single user log-in is used to gain access to a plurality of systems without being prompted to log in again to each system. Based on the single user sign-on, the single sign-on system may provide access to a plurality of secure resources, each having a different authentication mechanism. While a single sign-on system greatly increases convenience to the user, authentication and security become particularly critical because access is potentially provided to a large number of sensitive accounts.

An important trend has been the increasing use of soft-keyboards that are displayed within an application window and are used for entering information on a wide range of different types of devices. Software keyboards are representations of keyboards that are displayed on a visual display, in combination with a pointing device that is used by a user to select keys. The pointing device may, for example, be a mouse, a touchpad or a touchscreen. In any case, an operation of entering data using a software keyboard is referred to herein as “keying” the data.

Devices increasingly incorporating software keyboards include devices with hardware keyboards such as traditional desktop devices and phones with hardware keyboards. Because traditional hardware keys are extremely vulnerable to eavesdropping via key logging malware, many devices and services now use a supplementary soft-keyboard that is displayed within an application window.

Soft keyboards are also widely used on devices with no hardware keyboard, such as ATM machines and smartphones with touchscreens. In those devices, a soft keyboard is the principal means for a user to enter information into an application program.

A problem with existing instances of soft keyboards is that it is possible to infer which keys are pressed. For example, recent research has revealed that in smartphone and tablet devices, it is possible for malicious software to infer the x-y coordinates of a user's tap on the touchscreen. Given their popularity, sensor-rich smartphones and tablets are increasingly becoming targets of attacks that compromise users' privacy. The malicious software may even take the form of a useful application that can be downloaded from a popular application store, such as the Apple App Store or the Google Android Market. Unless the access to sensor or personal data is restricted by the system or by the user, malicious software can use official APIs to access the sensor data and upload it to third party servers without the user's consent.

The only sensor that requires explicit user access permission on both the Android and the iPhone platforms today is the location sensor. Indeed, most users perceive their location as being private and few would be happy to see their location tracks publicly available.

In contrast, accessing the accelerometer and gyroscope sensor data does not require explicit user permission on any major mobile platform. Those sensors, initially introduced to drive the device's user interface, are mostly used for gaming and widely perceived as innocuous. For example, the Android OS allows background running services with accelerometer and gyroscope sensor access without restrictions. Moreover, there is work aimed at the standardization of JavaScript access to a device's accelerometer and gyroscope sensors in order for any Web application to perform, for example, website layout adaptation. It has been shown, however, that accelerometer and gyroscope sensor data can be used for serious privacy breach. Specifically, it had been demonstrated that it is possible to infer where a user taps on a screen and what a user types by applying machine learning analysis to the stream of data from those two motion sensors. The accelerometer and gyroscope sensors are particularly useful in making such inferences because they are able to capture tiny device vibrations and angle rotations, respectively, with good precision.

The existence of the above-described threat is enabled by several additional factors. First, malicious software, if installed on a device, would have access to the stream of accelerometer and gyroscope data. The software might be: i) be secretly installed on a user's device through a remotely accessible backdoor or physical access; ii) take the form of a seemingly legitimate application; or iii) be embedded in a harmless-looking web page (if JavaScript access to a device's motion sensors is realized). Instead of continuously eavesdropping on the user, the malicious software might monitor the user's activity periodically or react to external events, such as the reception or transmission of a text message, or the use of the software keyboard.

Second, the malicious software likely has a way to send the observed data to a remote server either directly or through another application. Indeed, such remote communications capabilities will soon be unnecessary because the growing computation capabilities of mobile devices will, at some point, make it possible to run a location-learning algorithm entirely on a mobile device, thus requiring little communication with backend servers. Third, the attacker is likely able to obtain or learn a tap classification model. For best accuracy, the model would be learned using taps from the specific user on whom the attacker is eavesdropping. It has been shown, however, that the attacker could also train a tap classier using data from a small number of other people and use it effectively to infer taps from unaware users at a large scale while collecting their motion sensor data.

Several demonstrations have shown that the inference may be drawn by applying machine learning algorithms to the stream of accelerometer and gyroscope sensor data that is freely available to mobile application programmers. Once the tap location is known, it is possible to map with a high degree of accuracy the tap location to keys on the software keyboard, and to thereby accurately log keystrokes.

That research illustrates a wider problem with software keyboards. Software keyboards are being increasingly used in a variety of devices, including ATMs, kiosks, desktop apps and mobile devices. There are various ways for an attacker to determine the x-y coordinates of a key press on a soft-keyboard, in addition to the use of gyroscope and accelerometer sensors as described above. All software keyboard applications therefore share a common weakness, in that it is very hard to ensure that no malware inferring key taps will ever run on a device.

The present disclosure addresses the problem of enabling users to securely enter information using soft-keyboards, while preventing attackers from snooping that information. Specifically, a novel, effective and practical solution is disclosed to solve the above problem, whereby secure information input is realized for a range of devices/platforms.

In addressing the problem, it is assumed that it will be difficult or impossible to completely prevent malware from running on a device. Further, it is assumed that the increasing range of sensors on devices and all around will make it possible at times to infer the coordinates on the screen where the user is entering information. Those inferences may be via hardware sensors like accelerometers and gyroscopes or via other known and unknown means.

The general approach implemented in the present disclosure is to secure information entry by making information gathered by an attacker useless. The approach may involve a combination of one or more of the following. Within a given session, an application presenting a software input keyboard to a user may randomly vary relative sizes of each key within the keyboard. The exact location of each key within the session may also be randomly determined. That may be done, for example, by using a technique to randomly determine where and in what orientation on the screen to display the keyboard. The technique may further randomly determine the relative position of each key in the keyboard.

The term “random,” as used herein, is used to describe a set of outcomes having substantially equal probabilities. The present disclosure uses the term “random” to describe both true random events and pseudorandom events. For example, a random outcome, as defined herein, may be generated using a value from a table of randomly or pseudorandomly generated numbers or from an algorithmic pseudorandom number generator.

The described secure input techniques may be applied across different sessions, with the application making the above decisions anew each time a session is initiated. The techniques may alternatively be applied before each character is input using the software keyboard.

Each of the proposed solutions above achieves a high degree of security by significantly increasing the space of possibilities that an attacker needs to search for mapping a key press to useful information. The above techniques (i) randomly or pseudo-randomly locate the coordinates on the screen that map to a particular key and (ii) change the location decision at every new session and/or within each session. Those techniques make it virtually impossible to engineer a reverse mapping of specific coordinates to keystrokes by exponentially increasing the search space for each mapping problem.

The above techniques may be implemented in a device offering multiple types of keyboards for different types of user input. For example, a default software keyboard in a fixed location may be used for input of non-sensitive information, such as entering search terms for searching the Web. For more sensitive applications, the application switches to a secure keyboard.

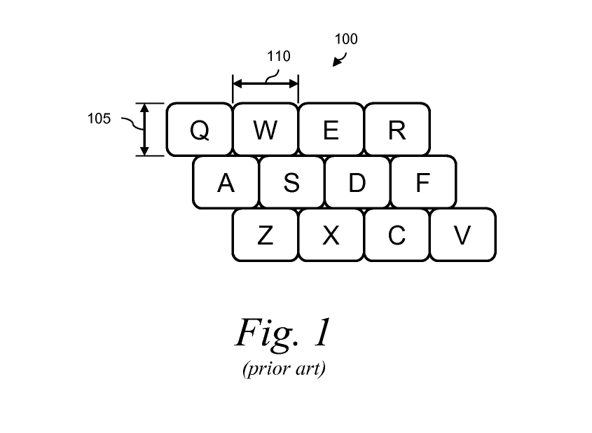

A portion of a standard prior art software keyboard 100 is shown in FIG. 1. Each of the letters in the alphabet is represented by a rectangular key representation having a vertical dimension 105 and a horizontal dimension 110. The keys are arranged in offset horizontal rows in a standard configuration originally used in typewriters, in which the first six letters represented in the top row are “QWERTY.” In general, the keys used in representing the letters of the alphabet each have the same vertical dimension 105 and the same horizontal dimension 110. Keys representing the numerals 1 through 10 also have the same dimensions, as do keys representing special symbols and characters. In some frequently-used arrangements, keys that produce special functions, such as shift,” “enter” and “backspace,” may have dimensions different from those of the letter, number and symbol keys. As used herein, the term “standard keyboard” is used to describe a keyboard configuration having relative key sizes as described above, with at least the keys representing letters and numbers being substantially equal in size. A “non-standard” keyboard is a keyboard having a configuration departing from that of the standard keyboard configuration.

The use by many applications of the standard software keyboard configuration generated by the device operating system renders the key logging attacks described above possible. Screen location coordinates inferred from the device sensors can be mapped to particular keys on a standard software keyboard. The fact that screen locations map consistently to keyboard keys means that the mapping can be learned by an algorithm collecting data over time. The presently described technique renders the mapping of screen locations to keys considerably less straightforward or impossible by varying that mapping over time.

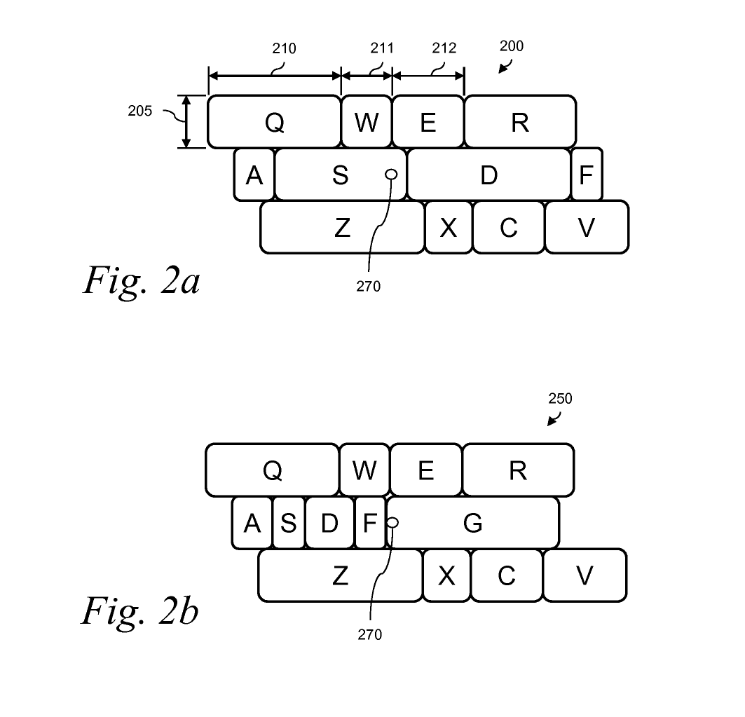

In one embodiment, the relative sizes of the keys within a keyboard configuration are varied over time. For example, a partial view of a software keyboard 200, in accordance with one embodiment of the disclosure, is shown in FIG. 2a, as it is presented to a user in a data input screen of a mobile application program. The relative horizontal dimensions of the keys are varied from key to key. In the example shown, the horizontal dimension 210 of the “Q” key is larger than the horizontal dimension 212 of the “E” key, which is larger than the horizontal dimension 211 of the “W” key.

The relative dimensions of the keys are generated randomly or pseudo-randomly for each keyboard configuration of a series of software keyboard configurations presented to the user over time. In a subsequent keyboard configuration (not shown) that is presented to the user, different relative dimensions are used. For example, the “Q” key may be smaller than the “E” key, or the “Q” key may be larger than the “E” key by a smaller percentage than that shown in FIG. 2a.

It can be seen that, by randomly varying the horizontal dimension of each key from key to key and from software keyboard configuration to software keyboard configuration, a single location on a touchscreen represents numerous different letters or numbers. For example, the touchscreen location 270 of the keyboard configuration 200 of FIG. 2a maps to the letter “S.” In another keyboard configuration 250 shown in FIG. 2b, the same touchscreen location 270 maps to the letter “G.”

In the example of FIG. 2a, the vertical dimension 205 of the keys is maintained at a constant value from key to key and over time. That feature makes the keyboard more recognizable to a user while still varying the relative sizes of the keys. Additional techniques may be used to further facilitate the use of multiple keyboard configurations by a user. For example, while relative horizontal dimensions of the keys within a row may be generated randomly, those horizontal dimensions may be scaled to cause the overall row to have a length similar to that of a standard keyboard. Alternatively, the row may be randomly centered, right-justified or left-justified.

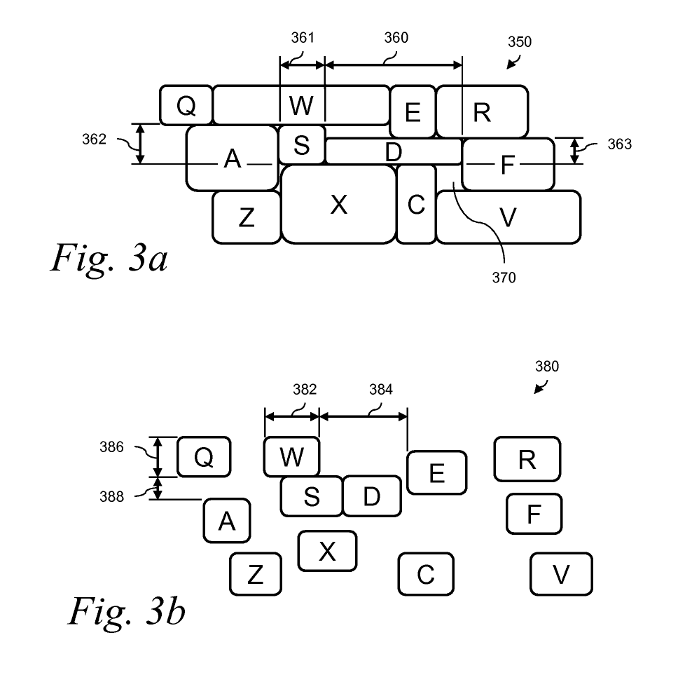

In another embodiment, exemplified by a partial view of a software keyboard 350 of FIG. 3a, the relative sizes of the key representations are varied from key to key and from software keyboard configuration to software keyboard configuration by varying both the horizontal dimensions and the vertical dimensions. For example, a horizontal dimension 360 of the “D” key is greater than a horizontal dimension 361 of the “S” key, while a vertical dimension 362 of the “S” key is greater than a vertical dimension 363 of the “D” key. By varying both the horizontal and vertical dimensions of the key representations, a mapping of screen locations to keyboard keys is further decoupled.

It can be seen from the keyboard configuration 350 of FIG. 3a that varying both the horizontal and the vertical dimensions of the keys may result in areas such as area 370 that are not mapped to any key. That condition may be acceptable, in which case the keyboard configuration 350 is used as shown. Alternatively, the inter-key spaces may be mapped to a random one of the adjacent keys. For example, the keyboard configuration 350 may be modified by giving the “F” key a non-rectangular, interlocking shape having an extension filling the space 370.

A different keyboard configuration, having different relative sizes or dimensions of the key representations, may be used for entering each one of the single digits or characters of a secure entry. For example, in entering a five-digit password, five different keyboard configurations, each having different relative key sizes, may be presented to a user in a sequence. Each configuration is used for entering a single digit. Such a technique provides maximum security against key logging, but requires the user to readjust to the changes between each keystroke.

In the software keyboard 380 shown in FIG. 3b, spacing between the keys is varied to increase the key mapping search space. For example, a horizontal dimension 382 of the “W” key is reduced as compared to a standard keyboard of comparable size, and a space 384 between the “W” key and the neighboring “E” key is created. That space 384 does not map to any key. Similarly, a vertical dimension 386 of the “Q” key is reduced and a space 388 is created between the “Q” and “A” keys. The software keyboard 380 includes a set of inter-key spacings that varies within the keyboard configuration and may be varied in subsequent keyboard configurations. The mapping of keys to display locations from key to key and over time therefore changes. Because a particular display location may map to different keys (or even to no key) in different keyboard configurations, the search space for identifying a mapping is greatly increased.

In the case of a single sign-on system, where a single user log-in is used to provide access to multiple accounts, a high degree of protection against key logging is especially desirable. The presently disclosed techniques provide such protection. Furthermore, limiting authentication to a single log-in permits the imposition of some inconvenience in the log-in process, such as requiring the user to use a non-standard software keyboard, or requiring the user to re-adjust to a new keyboard configuration after each character entry. The presently disclosed technique is therefore particularly well-suited for use with a single sign-on system.

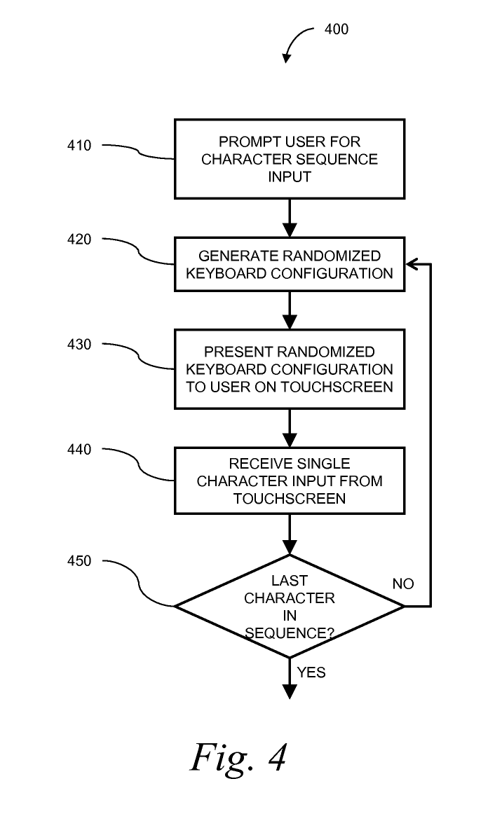

An example flowchart 400 showing such a technique is shown in FIG. 4. A user is initially prompted at operation 410 to input a character sequence such as a password or account number. For example, the device may prompt, “Please enter your password using the displayed keyboard.” The device then generates a randomized keyboard configuration at operation 420. The configuration may be generated, for example, using a table of randomly or pseudorandomly generated numbers, or may be generated using an algorithmic pseudorandom number generator. The generated software keyboard is then presented to the user at operation 430.

The device receives a single character input from the user in operation 440. That input is generated by the user by indicating a location on the screen that is mapped to a character value. For example, a user may tap on a touchscreen or may indicate a display location using a mouse. If the received character is not the last character in the sequence, as determined at decision 450, then the device repeats the process, generating another randomized keyboard configuration, presenting it on the display and receiving another input.

In another embodiment, a single keyboard configuration having a single generated non-standard keyboard configuration is used in entering all the digits of a password or other secure entry. In that case, while somewhat less secure than the previous example, the user sees a single configuration for inputting the entire password, and does not need to readjust to a new keyboard configuration for each keystroke.

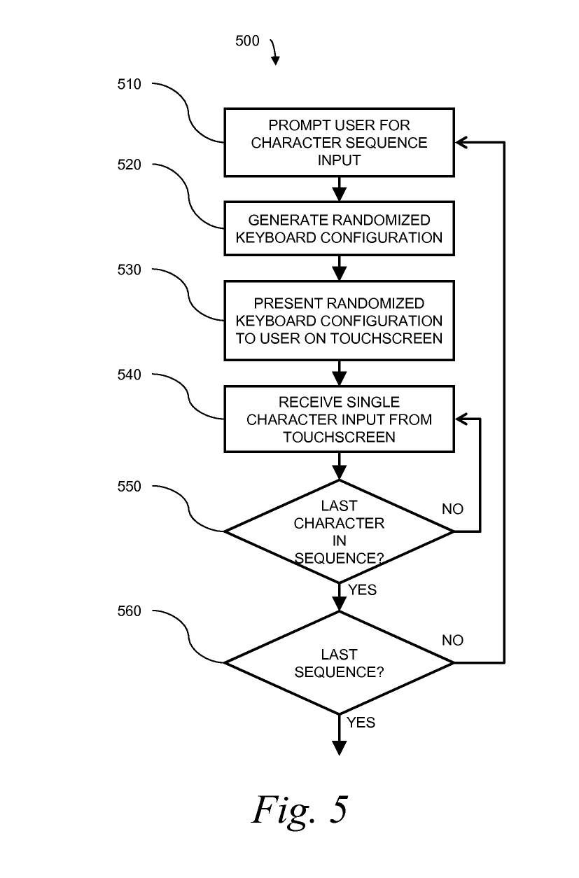

That technique is demonstrated in the example flowchart 500 of FIG. 5. As above, a user is initially prompted to input a character sequence at operation 510, the device generates a randomized keyboard configuration at operation 520, the generated keyboard is presented to the user at operation 530 and a single character input is received from the user at operation 540. If the received character is not the last character in the sequence (decision 550), however, a new keyboard configuration is not generated, and instead another character is received from the touchscreen at operation 540. After the sequence is completed, it is determined whether another sequence is to be entered at decision 560. For example, after entering an account number, the user may be prompted to enter a social security number. In that case, the user is prompted for the next sequence at operation 510, a new keyboard configuration is generated at operation 520, and the process is repeated.

It may readily be seen that, using random variations of the keyboard configurations of FIG. 2 and/or FIG. 3, a large number of combinations of relative key sizes is possible among the 26 letter keys and 10 number keys. Screen locations inferred by a malicious program from external sources such as accelerometer and gyroscope sensor measurements, even if accurate and repeatable, would be of little use to an algorithm attempting to learn a mapping of screen locations to particular keys, because that mapping randomly changes over time.

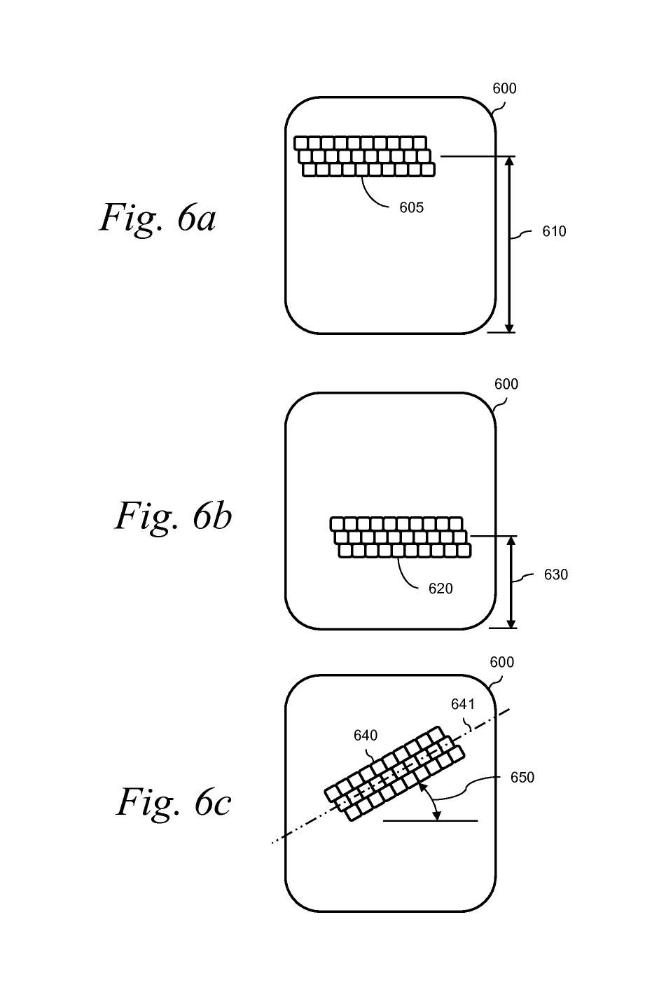

Other keyboard variation techniques may be used either alone or in combination with the above described technique to additionally protect data entered using a software keyboard. For example, the entire software keyboard may be moved within a display, changing the mapping of the display locations to the keys. As shown in FIG. 6a, the software keyboard 605 is displayed a distance 610 from the lower edge of the display 600. In a subsequent data entry operation shown in FIG. 6b, the software keyboard 620 is displayed a distance 630 from the lower edge of the display 600. An algorithm attempting to learn a mapping of screen locations to keystrokes would require greatly increased complexity and far greater sample sizes to deal with such a “moving” keyboard.

In another technique shown in FIG. 6c, the keyboard is 640 is displayed in an oblique orientation with respect to the edges of the display 600. As used herein, an “oblique” orientation is an orientation wherein a major axis of the keyboard representation is neither perpendicular nor parallel to the edges of the touchscreen display. The major axis 641 of the keyboard 640 is neither perpendicular nor parallel to the edges of the display 600, but is instead aligned at an oblique angle 650, which is neither 0 degrees nor 90 degrees. The angle 650 may be varied from keyboard configuration to keyboard configuration to further prevent a consistent mapping from display locations to keys.

The relative locations of the key representations within a software keyboard may also be varied. In the partial view 700 of a software keyboard configuration, the key locations are not the standard “QUERTY” keyboard locations, but are instead key locations that are randomly generated before displaying the software keyboard. While such a rearrangement of the keyboard in time is effective in preventing key/location mapping by malicious software, the changing locations of the keys may present difficulty to a user because each key must be “found” after the keyboard configuration changes.

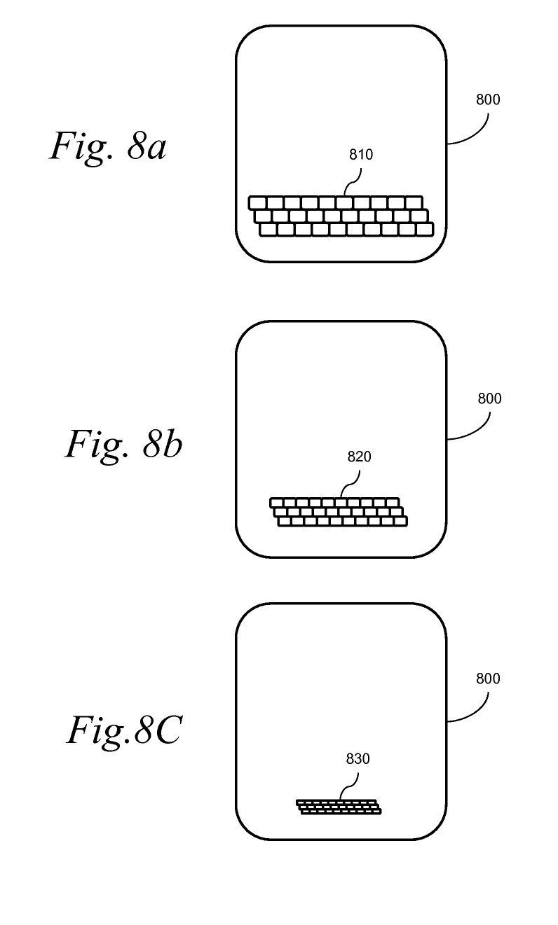

In addition to varying the sizes of individual keys from key to key and from keyboard configuration to keyboard configuration as described above with reference to FIGS. 2 and 3, the overall size of the full keyboard may be varied. As shown in FIG. 8a, a keyboard configuration 810 may be displayed on a display 800 in substantially a maximum size possible, as is customary for mobile device software keyboards. Keyboard configuration 820, shown in FIG. 8b, and keyboard configuration 830, shown in FIG. 8c, demonstrate variations in overall keyboard size. Differences in overall size among keyboard configurations used over time decouples locations on the display from keys within the keyboard.

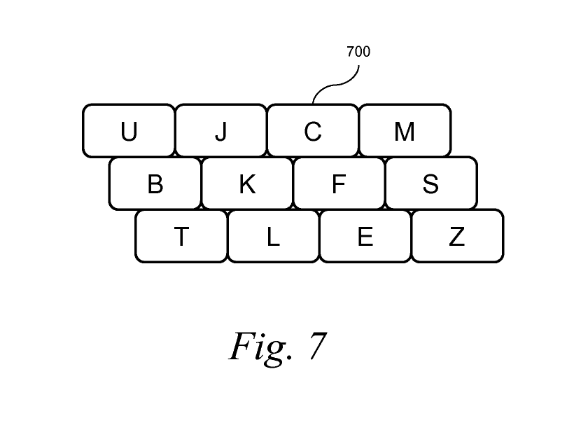

Each of the techniques for varying keyboard configurations discussed with reference to FIGS. 6-8 may be used alone or may be used in combination with the variation of individual key sizes described with reference to FIGS. 2 and 3.

Implementation

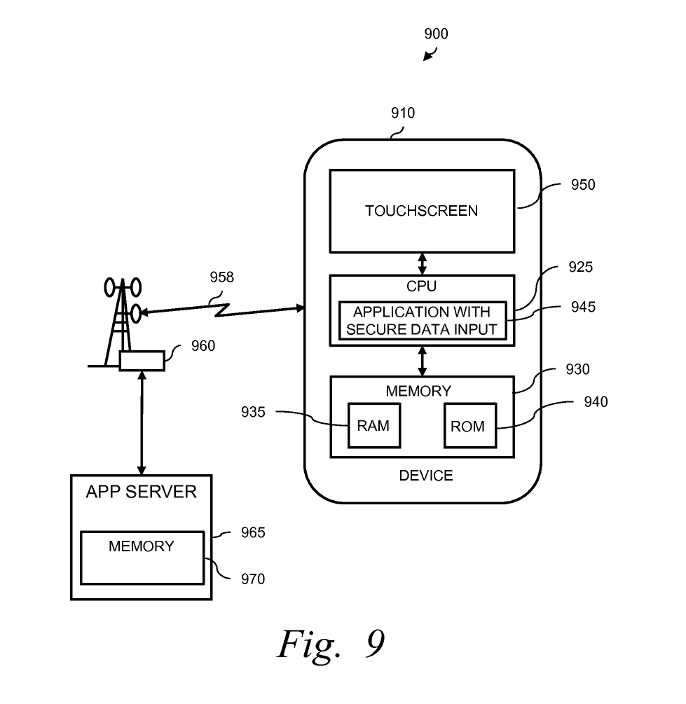

A system 900 for securely entering data via a software keyboard, according to an exemplary embodiment of the present disclosure, is illustrated in FIG. 9. In the system 900, a computing device 910 performs elements of the disclosed method. The computing device 910 may be a mobile communications device, a handheld computer, an automated teller machine, a retail kiosk, a laptop or desktop computer or any other device in which secure data input is desired. While the computing device 910 is shown as a single unit, one skilled in the art will recognize that the disclosed operations may be performed by a computer comprising a plurality of units linked by a network or a bus.

The device 910 may receive application program code and other data from any number of data sources such as an application server 965 that stores application programs and other data as computer readable code in a memory 970. The device 910 may receive the data from the server 965 via a wireless link 958 and wireless base station 960, which is connected to the application server 965 via a wide area network such as the Internet. Alternatively, data may be received directly via a wired connection, a local wireless network, etc.

The device 910 includes a central processing unit (CPU) 925 and a memory 930. The device 910 may be connected to input devices and output devices such as a touchscreen 950. Other input/output devices, such as a mouse, a voice interface, a network interface, a standard display screen or a printer may also be used. The device 910 can be configured to operate and display information by using the touchscreen 950 to execute certain tasks such as presenting graphical depictions of keyboards and receiving user input from touches on the depiction of the keyboard.

The CPU 925 may contain an operating system and one or more software applications, including a software application requiring user data input. The various techniques discussed above for presenting a software keyboard are preferably performed using software code contained in an application residing in the CPU. For example, a banking application permitting a user to perform banking transactions may contain code for presenting software keyboards in accordance with the techniques described above. The banking application may present a software keyboard having a high degree of security for user input of account numbers or passwords. On the other hand, a photo sharing application may present software keyboards having a lower level of security but having a greater ease of use. Code for performing operations to present secure software keyboards according to the present disclosure may alternatively be contained in the operating system of the device 910, which is also loaded into the CPU 925 from the memory 930.

The memory 930 includes a random access memory (RAM) 935 and a read-only memory (ROM) 940. The memory 930 may also include removable media such as a disk drive, tape drive, memory card, etc., or a combination thereof. The RAM 935 functions as a data memory that stores data used during execution of application programs in the CPU 925 and is used as a work area. The ROM 940 functions as a program memory for storing an application program executed in the CPU 925. The program may reside on the ROM 940 or on any other tangible computer-usable medium as computer readable instructions stored thereon for execution by the CPU 925 or another processor to perform the methods of the disclosure. The program may also reside on the memory 970 of the application server 965 for distribution to devices such as the device 910.

The above-described operations may be implemented by program modules that are executed by a computer, as described above. Generally, program modules include routines, objects, components, data structures and the like that perform particular tasks or implement particular abstract data types. The terms “program” and “application program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like. The disclosure may also be employed in distributed computing environments, where tasks are performed by remote processing devices that are linked through a communications network. In a distributed computing environment, modules may be located in both local and remote memory storage devices.

An exemplary processing module for implementing the methodology above may be hardwired or stored in a separate memory that is read into a main memory of a processor or a plurality of processors from a computer readable medium such as a ROM or other type of hard magnetic drive, optical storage, tape or flash memory. In the case of a program stored in a memory media, execution of sequences of instructions in the module causes the processor to perform the operations described herein. The embodiments of the present disclosure are not limited to any specific combination of hardware and software and the computer program code required to implement the foregoing can be developed by a person of ordinary skill in the art.

The term “computer-readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are transitory and not tangible. Cached information is considered to be stored on a computer-readable medium. Common expedients of computer-readable media are well-known in the art and need not be described in detail here.

### SUMMARY

The above-described techniques harden graphical user interface metaphors such as software keyboards against malicious attacks that try to infer the information being entered via those interfaces. The proposed solutions can be implemented at the application level itself, and require no additional support from the operating system or hardware. The technology therefore is practical and deployable.

The disclosed solution is furthermore independent of the type of sensor or information leak used to monitor key inputs. It works by making the space of mappings very large, irrespective of how an attacker obtains the coordinates. That makes the presently described approach effective against a range of monitoring attacks, including attacks using hardware sensors such as accelerometers, gyroscopes etc., as well as against attacks wherein the information leak occurs via other non-hardware means.

The same disclosed techniques can be used to provide secure information entry for applications on cellphones, desktop devices, ATMs, public kiosks, etc. For an application developer, such a uniform security model helps reduce costs and increase security across platforms.

The foregoing detailed description is to be understood as being in every respect illustrative and exemplary, but not restrictive, and the scope of the disclosure herein is not to be determined from the description, but rather from the claims as interpreted according to the full breadth permitted by the patent laws. It is to be understood that various modifications of this disclosure will be implemented by those skilled in the art, without departing from the scope and spirit of the disclosure.

What is claimed is:

1. A method for securing data input via a software keyboard, the method comprising:
generating, by processing hardware, a first software keyboard configuration including a plurality of key representations having a first set of predetermined sizes;
causing, by the processing hardware, a first software keyboard to be displayed on a screen according to the first software keyboard configuration;
receiving, by the processing hardware, data keyed using the first software keyboard;
generating, by the processing hardware, a second software keyboard configuration including a plurality of key representations having a second set of predetermined sizes, the second set of predetermined sizes being different from the first set of predetermined sizes;
causing, by the processing hardware, a second software keyboard to be displayed on the screen according to the second software keyboard configuration; and
receiving, by the processing hardware, data keyed using the second software keyboard.

2. The method of claim 1, wherein the key representations having the first set of predetermined sizes each have a same vertical dimension and vary in a horizontal dimension.

3. The method of claim 1, wherein the key representations having the first set of predetermined sizes vary in both a vertical dimension and a horizontal dimension.

4. The method of claim 1, wherein the first and second software keyboards have different overall horizontal dimensions.

5. The method of claim 1, wherein causing the second software keyboard to be displayed further comprises causing the second software keyboard to be displayed at a location on the screen different from a location of the first software keyboard.

6. The method of claim 1, wherein causing the second software keyboard to be displayed further comprises causing the second software keyboard to be displayed at an oblique angle on the screen different from an angle of the first software keyboard.

7. The method of claim 1, wherein the data keyed using the first software keyboard and the data keyed using the second software keyboard comprise a single prompted entry by a user.

8. The method of claim 1, wherein the data keyed using the first software keyboard comprises a first prompted entry by a user and the data keyed using the second software keyboard comprises a second prompted entry by a user different from the first prompted entry.

9. The method of claim 1, further comprising:
based on the data keyed using the second software keyboard, providing access to two or more secure resources having different authentication mechanisms.

10. The method of claim 1, wherein the second software keyboard configuration further includes a second set of predetermined inter-key spacings different from a first set of predetermined inter-key spacings included in the first software keyboard configuration.

11. A tangible computer-usable medium having computer readable instructions stored thereon for execution by one or more processors to perform operations for securing data input via a graphical user interface, the operations comprising:
generating a first software keyboard configuration including a plurality of key representations having a first set of predetermined sizes;
causing a first software keyboard to be displayed on a screen according to the first software keyboard configuration;
receiving data keyed using the first software keyboard;
generating a second software keyboard configuration including a plurality of key representations having a second set of predetermined sizes, the second set of predetermined sizes being different from the first set of predetermined sizes;
causing a second software keyboard to be displayed on the screen according to the second software keyboard configuration; and
receiving data keyed using the second software keyboard.

12. The tangible computer-usable medium of claim 11, wherein the key representations having the first set of predetermined sizes each have a same vertical dimension and vary in a horizontal dimension.

13. The tangible computer-usable medium of claim 11, wherein the key representations having the first set of predetermined sizes vary in both a vertical dimension and a horizontal dimension.

14. The tangible computer-usable medium of claim 11, wherein the first and second software keyboards have different overall horizontal dimensions.

15. The tangible computer-usable medium of claim 11, wherein causing the second software keyboard to be displayed further comprises causing the second software keyboard to be displayed at a location on the screen different from a location of the first software keyboard.

16. The tangible computer-usable medium of claim 11, wherein causing the second software keyboard to be displayed further comprises causing the second software keyboard to be displayed at an angle on the screen different from an angle of the first software keyboard.

17. The tangible computer-usable medium of claim 11, wherein the data keyed using the first software keyboard and the data keyed using the second software keyboard comprise a single prompted entry by a user.

18. The tangible computer-usable medium of claim 11, wherein the data keyed using the first software keyboard comprises a first prompted entry by a user and the data keyed using the second software keyboard comprises a second prompted entry by a user different from the first prompted entry.

19. The tangible computer-usable medium of claim 11, wherein the wherein the operations further comprise:
based on the data keyed using the second software keyboard, providing access to two or more secure resources having different authentication mechanisms.

20. The tangible computer-usable medium of claim 11, wherein the second software keyboard configuration further includes a second set of predetermined inter-key spacings different from a first set of predetermined inter-key spacings included in the first software keyboard configuration.
